(19) United States
(12) Patent Application Publication
(10) Pub. No.: US 2017/0371797 A1
(43) Pub. Date: Dec. 28, 2017

(54) PRE-FETCH MECHANISM FOR COMPRESSED MEMORY LINES IN A PROCESSOR-BASED SYSTEM

(71) Applicant: QUALCOMM Incorporated, San Diego, CA (US)

(72) Inventors: Andres Alejandro OPORTUS VALENZUELA, San Diego, CA (US); Nieyan GENG, San Diego, CA (US); Gurvinder Singh CHHABRA, San Diego, CA (US); Richard SENIOR, San Diego, CA (US); Anand JANAKIRAMAN, San Diego, CA (US)

(21) Appl. No.: 15/192,984

(22) Filed: Jun. 24, 2016

(51) Int. Cl. G06F 12/0877; G06F 12/0842

(52) U.S. Cl. CPC G06F 12/0877; G06F 12/0842; G06F 2212/604

(57) ABSTRACT

Some aspects of the disclosure relate to a pre-fetch mechanism for a cache line compression system that increases RAM capacity and optimizes overflow area reads. For example, a pre-fetch mechanism may allow the memory controller to pipeline the reads from an area with fixed size slots (main compressed area) and the reads from an overflow area. The overflow area is arranged so that a cache line most likely containing the overflow data for a particular line may be calculated by a decompression engine. In this manner, the cache line decompression engine may fetch, in advance, the overflow area before finding the actual location of the overflow data.

### FIELD OF THE DISCLOSURE

The technology of the disclosure relates generally to storing data in computer memory, and more particularly to accessing compressed memory lines in memory of a processor-based system.

### BACKGROUND

Computing devices are prevalent in society. These devices may include servers, computers, cellular telephones, portable digital assistants (“PDAs”), portable game consoles, palmtop computers, and other electronic devices. Computing devices conventionally include a processor-based system that performs computational tasks in a wide variety of applications. The processor-based system may be included with other integrated circuits designed to work together in a system-on-a-chip (“SoC”), to deliver functionality to a user. A conventional processor-based system includes one or more processors that execute software instructions. For example, some software instructions instruct a processor to fetch data from a location in a memory, perform one or more processor operations using the fetched data, and generate a stored result. As examples, software instructions can be stored in a system or some type of memory such as a main memory. The software instructions can also be stored in a specific type of memory such as a cache memory that allows faster access. For example, the cache memory (“cache”) can be a cache memory local to the processor, a shared local cache among processors in a processor block, a shared cache among multiple processor blocks, or a higher-level memory of the processor-based system. As processor-based systems increase in complexity and performance, the memory capacity requirements may also increase. However, providing additional memory capacity in a processor-based system increases cost and area needed for memory on an integrated circuit.

As an alternative, data compression is a promising approach for meeting the increasing memory capacity demands expected in future systems. Unfortunately, existing compression algorithms do not translate well when directly applied to main memory because they require the memory controller to perform non-trivial computations to locate a cache line within a compressed memory page, thereby increasing access latency and degrading system performance As a result, for example, accessing a particular cache line in memory may require access to metadata in the memory and an additional layer of address computation to determine the location of the compressed cache line in memory corresponding to the particular cache line. This can increase complexity, cost, and latency to a processor-based system employing memory capacity compression. These disadvantages are particularly highlighted in reads for the overflow area. In a cache line compression system for memory savings, fetching from the overflow area is expensive because reading from the memory overflow area has overheads incurred as the memory controller sets up the read (page opening and other overheads for example).

Accordingly, there is a need for systems, apparatus, and methods that overcome the deficiencies of conventional approaches.

### SUMMARY

The following presents a simplified summary relating to one or more aspects and/or examples associated with the apparatus and methods disclosed herein. As such, the following summary should not be considered an extensive overview relating to all contemplated aspects and/or examples, nor should the following summary be regarded to identify key or critical elements relating to all contemplated aspects and/or examples or to delineate the scope associated with any particular aspect and/or example. Accordingly, the following summary has the sole purpose to present certain concepts relating to one or more aspects and/or examples relating to the apparatus and methods disclosed herein in a simplified form to precede the detailed description presented below.

In one aspect, a memory device implementing a processing device for enabling pre-fetching of overflow data during retrieval of compressed data includes: a main compressed data area configured to store compressed data of a cache line, the cache line being a first size; an overflow data area configured to store overflow data of the cache line that exceeds the first size; and a memory access device for retrieval of the compressed data of the cache line and retrieval of an overflow line of the overflow data area based on the cache line being retrieved wherein the retrieval of the overflow line begins before the retrieval of the compressed data of the cache line is complete.

In another aspect, a method for retrieving compressed data includes: receiving a read request for compressed data; determining a first memory location for the compressed data; retrieving a first portion of the compressed data from the first memory location; calculating a second memory location for the compressed data based on the first memory location; retrieving a second portion of the compressed data from the second memory location before completing decompressing the first portion of the compressed data; decompressing the first portion of the compressed data; and decompressing the second portion of the compressed data immediately after decompressing the first portion of the compressed data.

In still another aspect, a method for retrieving overflow data includes: compressing first data; storing a first portion of the compressed first data in a first memory region, the first memory region being a fixed size; storing a second portion of the compressed first data in a second memory region, the second portion comprises a portion of the compressed first data that exceeds the fixed size; determining a second location of the second memory region based on a first location of the first portion of the compressed first data; retrieving the first portion of the compressed first data; and retrieving the second portion of data from the second location before completing a decompression of the first portion of the compressed first data.

Other features and advantages associated with the apparatus and methods disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 is a block diagram of an exemplary processor-based system that includes a memory access device configured to optimize overflow area reads in accordance with some examples of the disclosure;

FIGS. 2A and 2B are simplified diagrams of an overflow area build arrangement in accordance with some examples of the disclosure;

FIG. 3 is an exemplary method of retrieving compressed data in accordance with some examples of the disclosure;

FIG. 4 is an exemplary method of storing and retrieving compressed data in accordance with some examples of the disclosure; and

FIG. 5 illustrates an exemplary computing device, in which an aspect of the disclosure may be advantageously employed.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and drawings.

### DETAILED DESCRIPTION

The exemplary methods, apparatus, and systems disclosed herein address the industry needs, as well as other previously unidentified needs, and mitigate shortcomings of the conventional methods, apparatus, and systems. For example, a pre-fetch mechanism may be used to reduce latency during retrieval of data from a compressed cache line with a fixed size. Fixing the compressed size for compressed cache lines is a way to simplify calculation of the physical address of a compressed cache line. Those lines that do not fit in this fixed size are called overflows and may be placed in an overflow area. In conventional systems, the overflow area location is not known in advance and needs to be read from DRAM or other memory, which is expensive because reading from the DRAM overflow area has overheads incurred as the memory controller sets up the read (page opening and other overheads). However, pre-fetching overflow area data may optimize the overflow area reads. A pre-fetching mechanism will allow the memory controller to pipeline the reads from the area with the fixed size slots (main compressed area) and the reads from the overflow area. The overflow area may be arranged such that a cache line most likely containing the overflow data for a particular cache line may be calculated by the decompression engine without having to read from DRAM or other memory the location of the overflow area data. This avoids the overhead cost and latency associated with reading the address for overflow area data and allows the cache line decompression engine to fetch in advance the overflow area before finding the actual location of the overflow data.

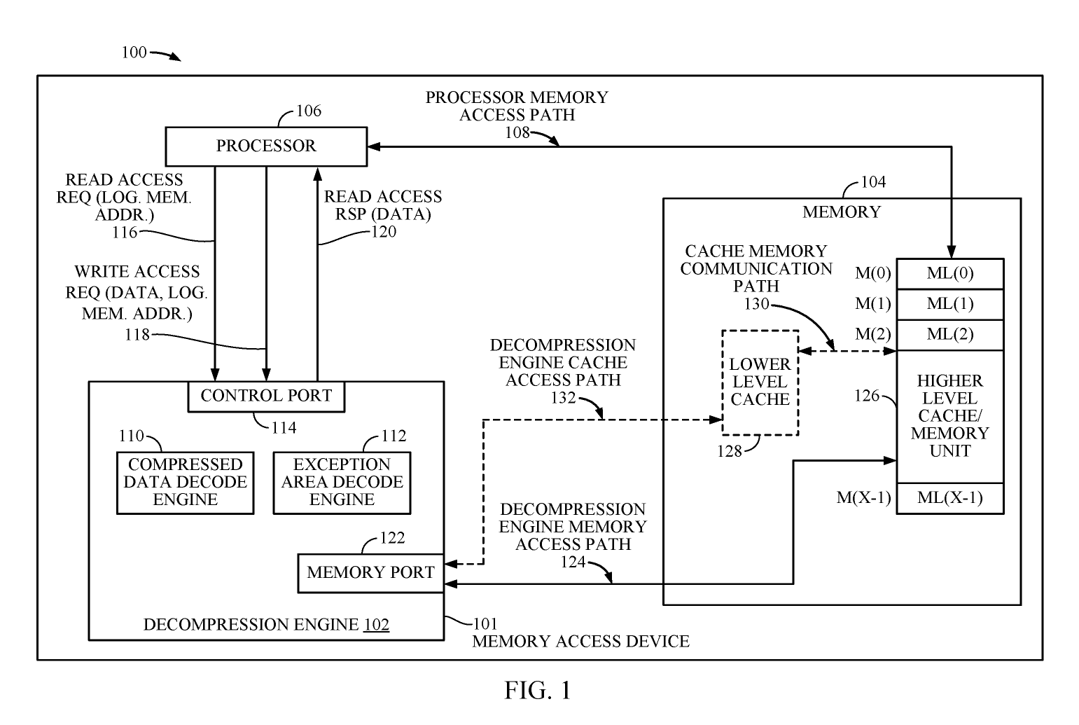

In this regard, FIG. 1 is a block diagram of an exemplary processor-based system 100. Before discussing the exemplary aspects of access of compressed memory lines in the processor-based system 100, a description of exemplary components of the processor-based system 100 is first described below.

The processor-based system 100 may include a memory access device 101 configured to provide access of compressed memory lines in a memory 104. The memory access device 101 may include a decompression engine 102 for reducing read access latency for overflow area read access requests in the processor-based system 100. The decompression engine 102 is configured to provide access of compressed memory lines stored in memory lines ML(0)-ML(X-1) of physical memory locations M(0)-M(X-1) in a memory 104 for reducing read access latency for overflow area read access requests, where ‘X’ represents any number of memory locations provided in memory 104. The processor-based system 100 further includes a processor 106. The processor 106 is configured to execute program instructions stored in memory 104 or otherwise utilize data stored in memory 104 to perform processor-based functionality. The processor 106 can also operate as a memory access device 101 and perform memory accesses to program instructions or data directly to memory 104 through a processor memory access path 108 (e.g., a bus). The processor 106 can also write data directly into memory 104 through the processor memory access path 108. The processor 106 can also perform memory accesses through the decompression engine 102. The decompression engine 102 is configured to control memory read accesses to memory 104, including decompressing data retrieved from memory 104 if compressed. The decompression engine 102 is configured to provide accessed data from memory lines ML(0)-ML(X-1) to the processor 106.

With continuing reference to FIG. 1, the decompression engine 102 includes a compressed data decode engine 110 configured to read compressed data from memory 104. The decompression engine 102 also includes an exception area decode engine 112 configured to read overflow area memory lines from memory 104. The decompression engine 102 further includes a control port 114 configured to facilitate an exchange of communications between the decompression engine 102 and the processor 106. Communication examples include a read access request 116 from the processor 106 that includes a logical memory address to request corresponding data. Communication examples further include a write access request 118 that includes data to be written into memory 104 and a corresponding logical memory address. Communication examples further include a read access response 120 to the processor 106 that includes requested data. The decompression engine 102 further includes a memory port 122 configured to facilitate an exchange of communications between the decompression engine 102 and memory 104 through a decompression engine memory access path 124.

In the exemplary processor-based system 100, memory 104 includes a memory unit 126 that stores compressed memory lines. Memory unit 126 includes X physical memory locations M(0)-M(X-1), each physical memory location M configured to store a memory line ML of a predetermined size of data, for example, sixty four (64) bytes. The compressed memory lines may be stored in memory unit 126 by the processor 106 through the processor memory access path 108, or by the decompression engine 102 through the decompression engine memory access path 124. In an exemplary aspect, each physical memory location M stores in each memory line ML a main compressed area and an overflow area.

In one exemplary aspect, memory 104 may operate as a multi-level cache memory. In this regard, memory unit 126 may operate as a higher level cache memory that stores compressed memory lines, and memory 104 may further include an optional lower level cache 128 that stores uncompressed memory lines previously accessed from memory unit 126 for faster read access. The optional lower level cache 128 may exchange communications with memory unit 126 through a cache memory communication path 130 and with the decompression engine 102 through a decompression engine cache access path 132. In this regard, if the logical memory address of the read access request 116 results in a cache hit at the optional lower level cache 128, the decompression engine 102 accesses the requested data at the optional lower level cache 128 and provides the requested data to the processor 106 in a read access response 120. However, if the logical memory address of the read access request 116 results in a cache miss at the optional lower level cache 128, the decompression engine 102 accesses the requested data by accessing a corresponding compressed memory line at memory unit 126, decompressing the compressed memory line, and providing the requested data to the processor 106 in the read access response 120.

To provide for access of compressed memory lines in memory 104 in the processor-based system 100, in one exemplary aspect, the decompression engine 102 receives a read access request 116 to access data from memory 104. The requested data is of up to a predetermined size, and each of the addressable physical memory locations M(0)-M(X-1) in memory 104 is configured to store a corresponding memory line ML(0)-ML(X-1) of the predetermined size. As noted earlier, each memory line ML(0)-ML(X-1) includes a main compressed area and an overflow area.

Each memory line ML(0)-ML(X-1) is configured to include a compressed data memory line as the main compressed area and an overflow area for compressed data that does not fit within the fixed size of the main compressed area. This allows memory 104 to store up to X compressed data memory lines, each within a corresponding memory line ML(0)-ML(X-1) of a corresponding physical memory location M(0)-M(X-1), or in other words, to store each of the up to X compressed data memory lines in a physical memory location M(0)-M(X-1) of memory 104 corresponding to a logical memory address of the corresponding compressed data. Further, this allows memory 104 to store the portion of compressed data that does not fit within the fixed size of the main compressed area memory lines, i.e., the overflow area, within the X physical memory locations M(0)-M(X-1) of memory 104, thus increasing capacity of memory 104 without increasing the size of memory 104. Accordingly, in the exemplary aspect, the decompression engine 102 can access compressed data in memory 104 with reduced latency, while increasing the capacity of memory 104.

In that regard, in this example, upon receiving a read access request 116, the decompression engine 102 determines if the read access request 116 involves the compressed data stored in the overflow area. For example, if the read access request 116 involves compressed data that exceeds the fixed size of the main compressed data area, then the read access request 116 will involve reading data from an overflow area to complete the read access request 116. To do so, the decompression engine 102 uses a logical memory address of the read access request 116 as the physical memory address to access a physical memory location M(0)-M(X-1) that contains the requested compressed data and calculates an overflow area location that is likely to contain the overflow area data for the read access request 116. The calculated overflow area location in memory 104 contains a memory line ML(0)-ML(X-1) that includes overflow area data (compressed data that did not fit in the fixed size of the main compressed area) corresponding to the read access request 116. Since the logical memory address of the read access request 116 is used as the physical memory address, the decompression engine 102 does not need to translate the logical address into a physical address. Thus, any latency associated with translating a logical address into a physical address is avoided. The decompression engine 102 can decompress the compressed data and provide the requested data via a read access response 120.

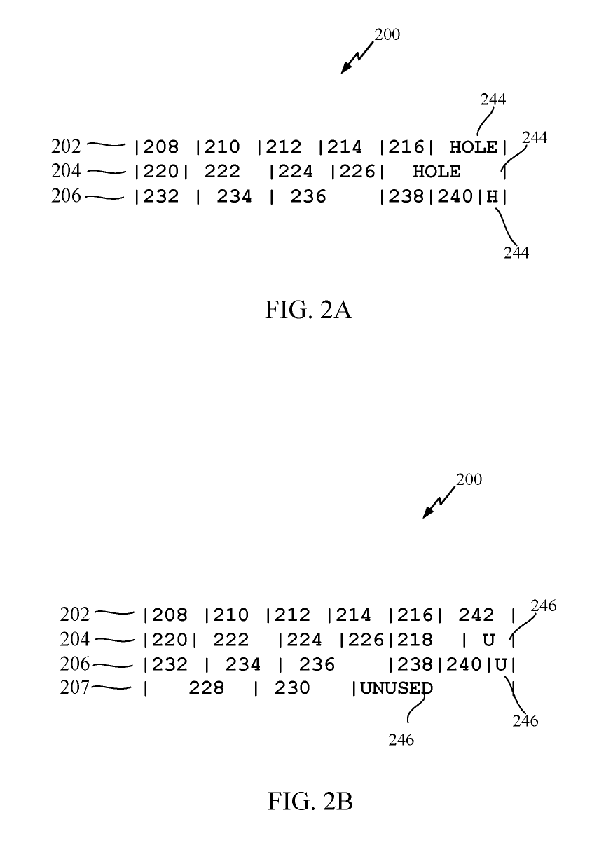

In one exemplary aspect, by arranging the overflow area at a build time (compressing and storing data using the processor 106 or the decompression engine 102) such that the overflow area location can be calculated for overflow area data, the decompression engine 102 may pipeline the read of the overflow area data with the read of the main compressed area data to reduce latency. It should be understood that arranging the overflow area may occur at build time or run-time as best suited for the application and/or type of data. In this regard, FIGS. 2A and 2B illustrate an exemplary overflow area build process. With regard to FIGS. 2A and 2B, an exemplary overflow area build process will be described that includes 6 overflow area entries per memory line and uses the formula: Line-to-read-in-overflow-area=overflow-area-entry-number/6.

For example, if the overflow area entry to read is 0-5 (208, 210, 212, 214, 216, and 218 in FIG. 2), then the fetch overflow area line is 0 (202 in FIG. 2). If the overflow area entry to read is 6-11 (220, 222, 224, 226, 228, and 230 in FIG. 2), then the fetch overflow area line is 1 (204 in FIG. 2). Similarly, if the overflow area entry to read is 12-17 (232, 234, 236, 238, 240, 242 in FIG. 2), then the fetch overflow area line is 2 (206 in FIG. 2). Dividing the overflow area entry number by 6, for example, may result in a 70% success rate. Since these are speculative fetches (see data entry 218 below, this is the fifth overflow area entry number that should likely be in the first overflow area line 202 but is actually in the second overflow area line 204 resulting in an incorrect fetch). With the speculative fetch matching 70% of the time (30% miss), total fetches grow by 30%, say from 100 to 130; however, 100 of the 130 fetches are hidden/pipelined with the read from the main compressed area. Non-pipelined fetches are reduced from 100 to 30. With data fetch overhead time 100 ns and decompression/read 5 ns: Without speculative fetch, Average total time=100 ns+5 ns+100 ns+5 ns=210 ns. With speculative fetching, Average total time=100 ns+5 ns+5 ns+0.3×(100 ns+5 ns)=141.5 ns″. Thus, the total time to fetch is reduced by 33%. This can be improved further by limiting the speculative fetching to those overflows most likely to succeed. For instance in the previous example pre-fetch only (line_n/6)<4. In other words, if the average number of compressed data entries per cache line is 6, as in this example, we would expect a high success rate if we limit the speculative pre-fetches to the first ⅔ of the average number of compressed data entries per cache line, 4 in this example. This is because the formula used to pre-fetch has, in this example, a known average success rate (likely success in the first ⅔ of the overflow area but unlikely in the last ⅓). This allows improving the total time to fetch and minimize pre-fetch misses.

With regard to FIG. 2A, an overflow area 200 may include a first overflow area line 202, a second overflow area line 204, and a third overflow area line 206. Each overflow area line 202, 204, and 206 corresponds to a memory line ML(0)-ML(X-1) with a fixed size. During build time, for example, each overflow area line 202, 204, and 206 may be populated with compressed data entries 208-242 if the addition of a respective compressed data entry 208-242 does not exceed the fixed size of the memory line. In this example, the fifth entry 218, the tenth entry 228, the eleventh entry 230, and the seventeenth entry 242 do not fit within the remainder or unpopulated portion of the fixed size the memory line (i.e. overflow area line 202, 204, or 206). These unpopulated portions 244 or unused bits are termed holes. At build time, the unpopulated portions 244 are filled with entries that did not fit (e.g. the fifth entry 218, the tenth entry 228, the eleventh entry 230, and the seventeenth entry 242). Entries that cannot be placed in a hole are added to the end of the overflow area.

After placing the entries that did not originally fit in the unpopulated portions 244, the remaining unused area of each overflow area line 202, 204, and 206 is minimized as can be seen in FIG. 2B. As shown, the seventeenth entry 242 is populated at the end of the first overflow area line 202, the fifth entry 218 is populated at the end of the second overflow area line 204 that leaves an unused portion/bits 246 at the end of the second overflow area line 204, and a fourth overflow area line 207 is used to store the tenth entry 228 and the eleventh entry 230 while leaving a large unused portion 246 at the end.

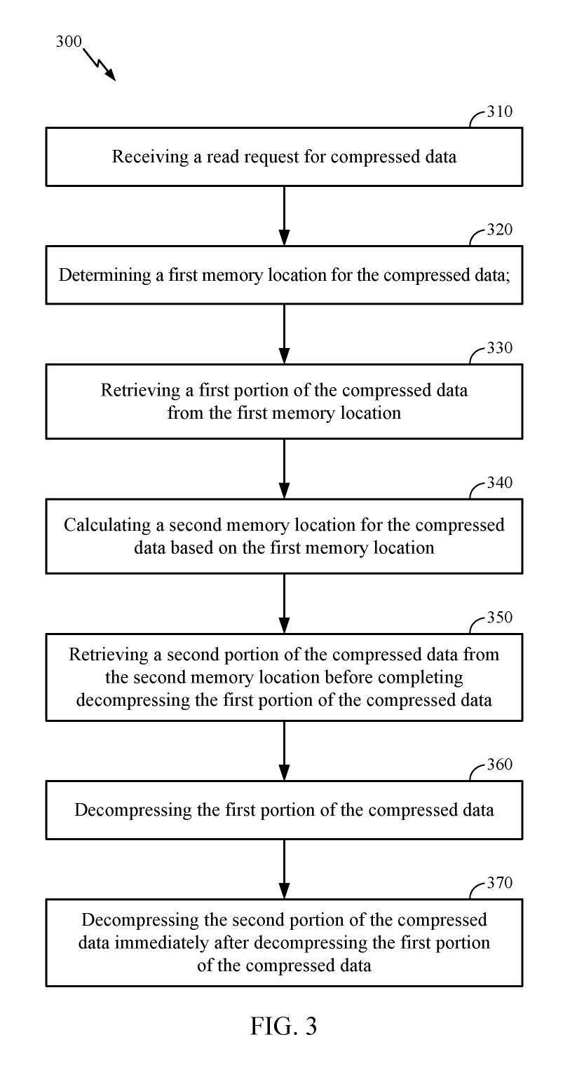

FIG. 3 is a flowchart illustrating an exemplary process 300 of the decompression engine 102 performing a read access request 116 to compressed memory lines in memory 104 in the processor-based system 100 in FIG. 1 for reducing read access latency. If the overhead time associated with reading a memory address is, for example, 100 ns, and the data read time for a memory line is 5 ns, then the time to read one memory line is 105 ns. However, when overflow area data is part of the read request and the pointer for the location of the overflow area data is stored in the compressed memory line, the read request initial overhead for the main compressed data is 100 ns, followed by 8 ns decompress time for the main compressed area data (this reveals the overflow area location—i.e., the pointer), then another 100 ns of overhead for the overflow area location, and finally another 8 ns to decompress the data from the overflow area associated with the read request for a total of 216 ns. Even when the pointer for the location of the overflow data is stored in a separate memory location from the main compressed data, the system will incur overhead to access that pointer location and read the pointer before starting to access the overflow data. By arranging the overflow area 200 as discussed above, the read request may avoid waiting for decompression of the main compressed data or having to lookup a pointer in another memory location by being able to calculate a likely location of any overflow data.

As discussed above, in the example of the processor-based system 100, the decompression engine 102 is called upon to perform the read access request 116 if a miss occurs to the optional lower level cache 128. In the exemplary process 300, the decompression engine 102 is configured to receive a read access request 116 from the processor 106 through the control port 114 (block 310). The read access request 116 includes a logical memory address for accessing a physical memory location M(0)-M(X-1) in memory 104. The decompression engine 102 is further configured to determine a first memory location based on the logical memory address for the compressed data (block 320) and retrieve through the memory port 122 the compressed data stored at a physical memory location M(0)-M(X-1) in memory 104 at the logical memory address of the read access request 116 (block 330). The decompression engine 102 is further configured to calculate a second memory location for the compressed data based on the first memory location and the formula 201 discussed above (block 340). The decompression engine 102 is further configured to retrieve through the memory port 122 a second portion of the compressed data stored at a physical memory location M(0)-M(X-1) in memory 104 at the calculated second memory location before completing decompression of the first portion of the compressed data (block 350). The decompression engine 102 is further configured to decompress the first portion of the compressed data (block 360). The decompression engine 102 is further configured to decompress the second portion of the compressed data immediately after decompressing the first portion of the compressed data (block 370).

Accordingly, the exemplary process 300 for read access of compressed memory lines in memory 104 may obviate the need to employ and access metadata in memory 104 or other memory and/or employ indexing to perform a translation, and the associated latency. Therefore, these exemplary aspects result in a higher overall memory access efficiency and reduced latency in the processor-based system 100.

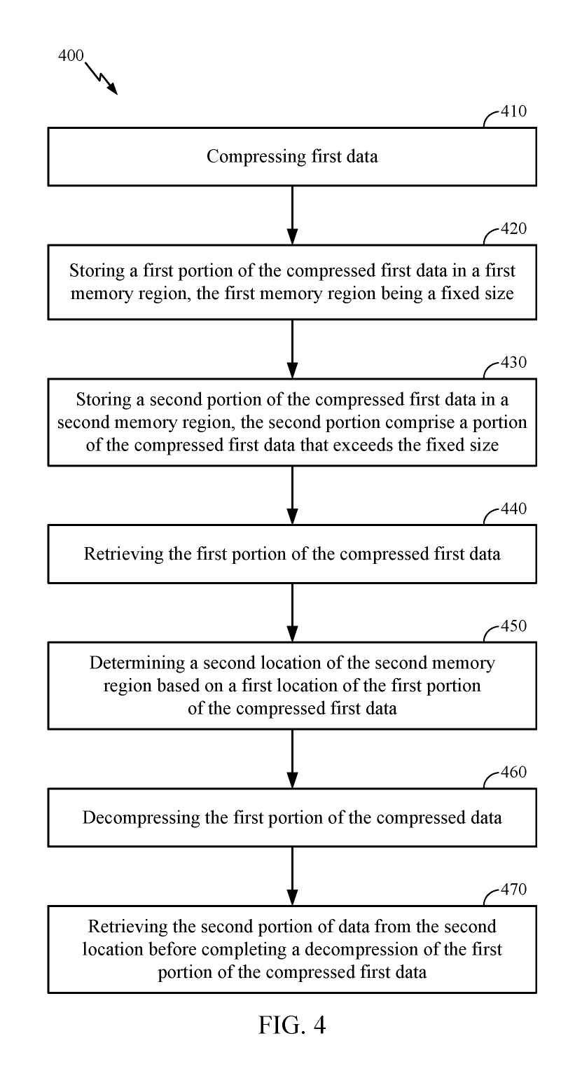

FIG. 4 is a flowchart illustrating an exemplary process 400 of the processor-based system 100 in FIG. 1 for reducing read access latency. As discussed above, in the example of the processor-based system 100, the decompression engine 102 or processor 106 is called upon to compress first data (block 410). Then, decompression engine 102 or processor 106 is called upon to store a first portion of the compressed first data in a first memory region, the first memory region being a fixed size (block 420). In addition, decompression engine 102 or processor 106 is called upon to store a second portion of the compressed first data in a second memory region, the second portion comprises a portion of the compressed first data that exceeds the fixed size (block 430). In the exemplary process 400, the decompression engine 102 is configured to receive a read access request 116 from the processor 106 through the control port 114. The read access request 116 includes a logical memory address for accessing a physical memory location M(0)-M(X-1) in memory 104. The decompression engine 102 retrieves the first portion of the compressed first data (block 440). The decompression engine 102 then determines (e.g. calculates using formula 201 above) a second location of the second memory region based on a first location of the first portion of the compressed first data (block 450). The decompression engine 102 begins decompressing the first portion of the compressed data (block 460). The decompression engine 102 retrieves the second portion of data from the second location before completing a decompression of the first portion of the compressed first data (block 470).

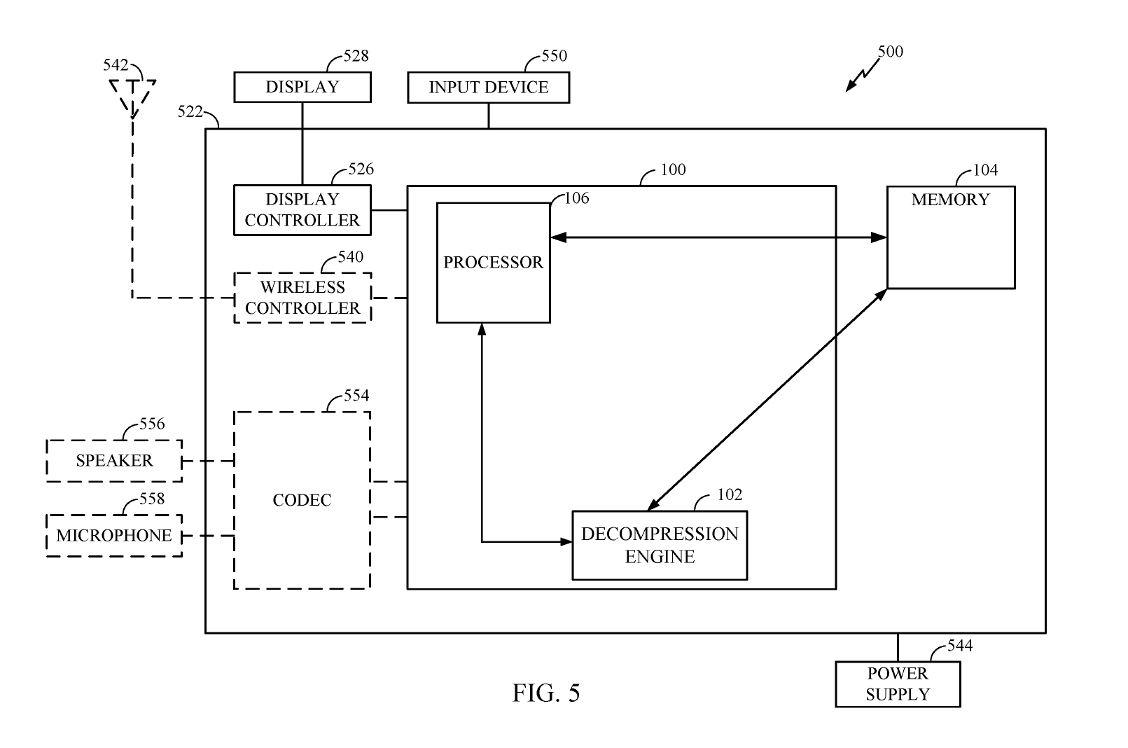

Referring now to FIG. 5, a block diagram of a computing device that is configured according to exemplary aspects is depicted and generally designated 500. In some aspects, computing device 500 may be configured as a wireless communication device or a server. As shown, computing device 500 includes processor-based system 100 of FIG. 1, which may be configured to implement processes 300 and/or 400 of FIGS. 3 and 4 in some aspects. Processor-based system 100 is shown in FIG. 5 with decompression engine 102, memory 104, and processor 106 while other details of the processor-based system 100 that were previously described with reference to FIG. 1 have been omitted from this view for the sake of clarity.

Processor-based system 100 may be communicatively coupled to memory 104. Computing device 500 may also include a display 528 and a display controller 526 coupled to processor-based system 100 and to display 528. It should be understood that the display 528 and the display controller 526 are optional.

In some aspects, FIG. 5 may include some optional blocks showed with dashed lines. For example, computing device 500 may optionally include coder/decoder (CODEC) 554 (e.g., an audio and/or voice CODEC) coupled to processor-based system 100; speaker 556 and microphone 558 coupled to CODEC 554; and wireless controller 540 (which may include a modem) coupled to wireless antenna 542 and to processor-based system 100.

In a particular aspect, where one or more of the above-mentioned optional blocks are present, processor-based system 100, display controller 526, CODEC 554, and wireless controller 540 can be included in a system-in-package or system-on-chip device 522. Input device 550, power supply 544, display 528, input device 550, speaker 556, microphone 558, wireless antenna 542, and power supply 544 may be external to system-on-chip device 522 and may be coupled to a component of system-on-chip device 522, such as an interface or a controller.

It should be noted that although FIG. 5 depicts a computing device, processor-based system 100 and memory 104 may also be integrated into a set top box, a music player, a video player, an entertainment unit, a navigation device, a personal digital assistant (PDA), a fixed location data unit, a server, a computer, a laptop, a tablet, a communications device, a mobile phone, server, or other similar devices.

The word “exemplary” is used herein to mean “serving as an example, instance, or illustration.” Any details described herein as “exemplary” are not to be construed as advantageous over other examples. Likewise, the term “examples” does not mean that all examples include the discussed feature, advantage or mode of operation. Furthermore, a particular feature and/or structure can be combined with one or more other features and/or structures. Moreover, at least a portion of the apparatus described hereby can be configured to perform at least a portion of a method described hereby.

The terminology used herein is for the purpose of describing particular examples and is not intended to be limiting of examples of the disclosure. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, actions, operations, elements, and/or components, but do not preclude the presence or addition of one or more other features, integers, actions, operations, elements, components, and/or groups thereof.

It should be noted that the terms “connected,” “coupled,” or any variant thereof, mean any connection or coupling, either direct or indirect, between elements, and can encompass a presence of an intermediate element between two elements that are “connected” or “coupled” together via the intermediate element.

Any reference herein to an element using a designation such as “first,” “second,” and so forth does not limit the quantity and/or order of those elements. Rather, these designations are used as a convenient method of distinguishing between two or more elements and/or instances of an element. Also, unless stated otherwise, a set of elements can comprise one or more elements.

Further, many examples are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the examples described herein, the corresponding form of any such examples may be described herein as, for example, “logic configured to” perform the described action.

Nothing stated or illustrated in this application is intended to dedicate any component, action, feature, benefit, advantage, or equivalent to the public, regardless of whether the component, action, feature, benefit, advantage, or the equivalent is recited in the claims.

Further, those of skill in the art will appreciate that the various illustrative logical blocks, modules, circuits, and algorithm actions described in connection with the examples disclosed herein may be implemented as electronic hardware, computer software, or combinations of both. To clearly illustrate this interchangeability of hardware and software, various illustrative components, blocks, modules, circuits, and actions have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Although some aspects have been described in connection with a device, it goes without saying that these aspects also constitute a description of the corresponding method, and so a block or a component of a device should also be understood as a corresponding method action or as a feature of a method action. Analogously thereto, aspects described in connection with or as a method action also constitute a description of a corresponding block or detail or feature of a corresponding device. Some or all of the method actions can be performed by a hardware apparatus (or using a hardware apparatus), such as, for example, a microprocessor, a programmable computer or an electronic circuit. In some examples, some or a plurality of the most important method actions can be performed by such an apparatus.

It should furthermore be noted that methods disclosed in the description or in the claims can be implemented by a device comprising means for performing the respective actions of this method.

Furthermore, in some examples, an individual action can be subdivided into a plurality of sub-actions or contain a plurality of sub-actions. Such sub-actions can be contained in the disclosure of the individual action and be part of the disclosure of the individual action.

While the foregoing disclosure shows illustrative examples of the disclosure, it should be noted that various changes and modifications could be made herein without departing from the scope of the disclosure as defined by the appended claims. The functions and/or actions of the method claims in accordance with the examples of the disclosure described herein need not be performed in any particular order. Additionally, well-known elements will not be described in detail or may be omitted so as to not obscure the relevant details of the aspects and examples disclosed herein. Furthermore, although elements of the disclosure may be described or claimed in the singular, the plural is contemplated unless limitation to the singular is explicitly stated.

What is claimed is:

1. A memory device comprising:
a main compressed data area configured to store compressed data of a cache line, wherein the cache line is of a first size;
an overflow data area configured to store overflow data of the cache line that exceeds the first size; and
a memory access device configured to retrieve the compressed data of the cache line and configured to retrieve an overflow line of the overflow data area based on the cache line being retrieved wherein the retrieval of the overflow line begins before the retrieval of the compressed data of the cache line is complete.

2. The memory device of claim 1, further comprising a decompression engine configured to calculate an address of the overflow line based on the cache line being retrieved.

3. The memory device of claim 2, wherein the address of the overflow line is determined by an integer value of an overflow line number divided by a number of overflow area entries per overflow line.

4. The memory device of claim 3, wherein the memory access device is further configured to begin the retrieval of the overflow line before the retrieval of the compressed data of the cache line begins.

5. The memory device of claim 4, wherein the memory access device is further configured to complete the retrieval of the overflow line before the retrieval of the compressed data of the cache line begins.

6. The memory device of claim 4, wherein the memory access device is further configured to complete the retrieval of the overflow line before the retrieval of the compressed data of the cache line ends.

7. The memory device of claim 1, wherein the memory access device is further configured to determine an address of the overflow line without retrieval of pointer data.

8. The memory device of claim 1, wherein the memory device is incorporated into a device selected from a group consisting of a set top box, a music player, a video player, an entertainment unit, a navigation device, a personal digital assistant (PDA), a fixed location data unit, a computer, a laptop, a tablet, a communications device, a mobile phone, a server, or other similar devices.

9. A method for retrieving compressed data, the method comprising:
receiving a read request for compressed data;
determining a first memory location for the compressed data;
retrieving a first portion of the compressed data from the first memory location;
calculating a second memory location for the compressed data based on at least the first memory location;
retrieving a second portion of the compressed data from the second memory location before completing decompressing the first portion of the compressed data;
decompressing the first portion of the compressed data; and
decompressing the second portion of the compressed data immediately after decompressing the first portion of the compressed data.

10. The method of claim 9, wherein the calculating the second memory location comprises calculating an address of an overflow line based on a cache line being retrieved.

11. The method of claim 10, wherein the address of the overflow line is determined by an integer value of an overflow line number divided by a number of overflow area entries per overflow line.

12. The method of claim 11, wherein the retrieving the second portion of the compressed data begins before the decompressing the first portion of compressed data begins.

13. The method of claim 12, wherein the retrieving the second portion of the compressed data ends before the decompressing the first portion of compressed data begins.

14. The method of claim 12, wherein the retrieving the second portion of the compressed data ends before the decompressing the first portion of compressed data ends.

15. The method of claim 9, further comprising determining an address of an overflow line without retrieval of pointer data.

16. The method of claim 9, wherein the method is performed by a device selected from a group consisting of a set top box, a music player, a video player, an entertainment unit, a navigation device, a personal digital assistant (PDA), a fixed location data unit, a computer, a laptop, a tablet, a communications device, a mobile phone, a server, or other similar devices.

17. A method for storing and retrieving overflow data, the method comprising:
compressing first data;
storing a first portion of the compressed first data in a first memory region, the first memory region being a fixed size;
storing a second portion of the compressed first data in a second memory region, the second portion comprises a portion of the compressed first data that exceeds the fixed size;
determining a second location of the second memory region based on a first location of the first portion of the compressed first data;
retrieving the first portion of the compressed first data; and
retrieving the second portion of the compressed first data from the second location before completing a decompression of the first portion of the compressed first data.

18. The method of claim 17, wherein the determining the second location further comprises calculating the second location.

19. The method of claim 18, wherein the calculating the second location comprises calculating an address of an overflow line based on a cache line being retrieved.

20. The method of claim 19, wherein the address of the overflow line is determined by an integer value of an overflow line number divided by a number of overflow area entries per overflow line.

21. The method of claim 20, wherein the determining the second location of the second memory region begins before the retrieving the first portion of the compressed first data begins.

22. The method of claim 21, wherein the determining the second location of the second memory region ends before the retrieving the first portion of the compressed first data begins.

23. The method of claim 21, wherein the determining the second location of the second memory region ends before the retrieving the first portion of the compressed first data ends.

24. The method of claim 17, further comprising determining an address of an overflow line without retrieval of pointer data.

25. The method of claim 17, wherein the method is performed by a device selected from a group consisting of a set top box, a music player, a video player, an entertainment unit, a navigation device, a personal digital assistant (PDA), a fixed location data unit, a server, a computer, a laptop, a tablet, a communications device, a mobile phone, or other similar devices.
